(19) United States
(12) Patent Application Publication
(10) Pub. No.: US 2006/0072763 A1
(43) Pub. Date: Apr. 6, 2006

(54) Apparatus and method for storing data

(75) Inventors: Yong-kuk You, Seoul (KR); Yun-ho Choi, Seoul (KR); Chi-hurn Kim, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/244,007

(22) Filed: Oct. 6, 2005

Related U.S. Application Data
(60) Provisional application No. 60/616,119, filed on Oct. 6, 2004.

(30) Foreign Application Priority Data
Oct. 27, 2004 (KR) 10-2004-0086134

(51) Int. Cl. H04L 9/00

(52) U.S. Cl. 380/277

(57) ABSTRACT

Provided are an apparatus and method for storing data. The apparatus includes a directory key generator generating a directory key required for encrypting and decrypting the data by inputting a device-specific key to a key generating function, the device-specific key being unique information allocated to the device and stored in a secure region of the device. The data is stored in at least one directory, and the directory key is used in encrypting and decrypting the data in units of directories. Accordingly, it is possible to minimize consumption of resources required to encrypt and decrypt the data.

### CROSS-REFERENCE TO RELATED PATENT APPLICATIONS

This application claims the priorities of U.S. Provisional Application No. 60/616,119, filed on Oct. 6, 2004 in the USPTO, and Korean Patent Application No. 10-2004-0086134, filed on Oct. 27, 2004 in the Korean Intellectual Property Office, the disclosures of which are incorporated herein in their entirety by reference.

### BACKGROUND OF THE INVENTION

1. Field of the Invention

The present invention relates to an apparatus and method for storing data, and more particularly, to an apparatus and method for storing data by dividing data into directories and separately encrypting or decrypting the directories, thereby minimizing consumption of resources required for encrypting and decrypting the directions.

2. Description of the Related Art

In recent years, home appliances, such as digital versatile disc (DVD) players, have been developed to include a hard disc to store content such as audio/video (AV) data thereon. In general, content is encrypted using a predetermined encryption key and stored on the hard disc in order that it not be reproduced without permission. The content is reproduced by decrypting the encrypted content using a predetermined decryption key. After reproduction, the decrypted content is encrypted using a predetermined encryption key again and stored on the hard disc. In other words, a different encryption key is used whenever the content is encrypted to prevent the content from being hacked.

FIG. 1A is a block diagram of a conventional apparatus 10, e.g., a DVD player, which reproduces data. The apparatus 10 includes an external source 20 that provides content or content information, an external device 30 that uses the content or the content information, and a data storage device 40 that stores the content or the content information. The content information includes a content name, a content key, usage rules, and other information which are required to reproduce the content. The apparatus 10 cannot reproduce the content without the content information.

The external source 20 may be any device that can provide the content or content information from the outside of the apparatus 10. For instance, the external source 20 may be a videotape, a CD, a DVD, a satellite receiver, or a cable TV receiver.

The external device 30 is an apparatus, such as an MPEG decoder, which uses the content or the content information.

The data storage device 40 safely stores the content or the content information. That is, the data storage device 40 encrypts the content or the content information received from the external source 20, stores the result of encryption, decrypts the result of encryption, and transmits the result of decryption to the external device 30.

FIG. 1B illustrates a data structure of content information. Referring to FIG. 1B, the content information required to reproduce the content is sorted out and stored in directories. Each of the content information includes a content name, a content key, usage rules, and other information.

Referring to FIG. 1B, the content information of a first content is stored in a first directory, and the content information of a second content is stored in a second directory. Since the content information is indispensable to securing copyright for the content, the directories are stored in an area R of a hard disc of a data reproduction apparatus. The directories are treated as a file, i.e., a content information file, which is encrypted using a predetermined key generated by the data reproduction apparatus. The encryption key is referred to as a protection key, and stored in a safe region, e.g., a flash memory, of a data storage device, which cannot be separated from the data reproduction apparatus. The protection key is extracted from the flash memory and used for decrypting the content information whenever an external device reproduces the content information.

FIG. 1C is a block diagram of a conventional apparatus 100 for storing data. The apparatus 100 includes an encryption unit 110, a random number generator 120, a flash memory 130, a decryption unit 140, and a storage unit 150.

The random number generator 120 generates random numbers and creates a first protection key 122 using the random numbers. The first protection key 122 is used to protect content information stored in the apparatus 100, i.e., it is used when encrypting and decrypting the content information. The random number generator 120 creates the first protection key 122 by generating random numbers, and therefore, a different protection key is generated whenever an external device (not shown) requires a protection key.

The encryption unit 110 generates an encrypted content information file 112 by encrypting a content information file 102, which is a file R containing content information given from an external source (not shown), using the first protection key 122, and then stores the encrypted content information file 112 in the storage unit 150.

The first protection key 122 created by the random number generator 120 is stored in the flash memory 130. The flash memory 130 is a secure region which cannot be separated from the apparatus 100.

When an external device (not shown) requests the content information, the decryption unit 140 extracts the encrypted content information file 112 from the storage unit 150 and the protection key 122 from the flash memory 130, generates a decrypted content information file 142 by decrypting the encrypted content file 112 using the first protection key 122, and provides the decrypted content information file 142 to the external device.

After the external device uses the decrypted content information file 142, the decrypted content information file 142 is encrypted again by the encryption unit 110 and stored in the storage unit 150. In this case, a second protection key 124 is created by the random number generator 120 and used to encrypt the decrypted content information file. The second protection key 124 is different from the first protection key 122 that was used to encrypt the content information file 102.

FIG. 2 is a flowchart illustrating a conventional method of storing data in the apparatus of FIG. 1C. Referring to FIG. 2, the random number generator 120 generates random numbers and creates the first protection key 122 using the random numbers (operation 210).

Next, the encryption unit 110 generates an encrypted content information file 112 by encrypting the content information file 102 using the first protection key 122, and stores the encrypted content information file 112 in the storage unit 150 (operation 220).

Next, the first protection key 122 is stored in the flash memory 130 (operation 230).

When an external device, e.g., a DVD player, requests the content information file 102 to obtain the first content key 122 (operation 240), the decryption unit 140 extracts the encrypted content information file 112 from the data storage unit 150 and the first protection key 122 from the flash memory 130 (operation 250). Next, the decryption unit 140 generates the decrypted content information file 142 by decrypting the encrypted content information file 112 using the first protection key 122, and provides the decrypted content information file 142 to the external device (operation 260). Next, the external device obtains the first protection key 122 from the decrypted content information file 142 and reproduces the desired content (operation 270).

After the external device reproduces the content, the decrypted content information file 142 is encrypted again by the encryption unit 110 and stored in the storage unit 150. That is, the decrypted content information file 142 is encrypted again by performing operations 210 through 230. In this case, the second protection key 124 is created by the random number generator 120 and used to encrypt the decrypted content information file 142. The second protection key 124 is different from the first protection key 122 that was used to encrypt the content information file 102. In other words, after the external device uses a content information file to reproduce content, the content information file is encrypted again by a protection key different from a protection key that was used to encrypt the content information file, thereby preventing the content information file from being hacked.

However, a conventional apparatus and method for storing data has a defect since a content information file containing one or more contents is encrypted using a protection key and stored. For instance, content information regarding a first content is changed by decoding the entire content information file, changing the content information regarding the first content, encrypting the entire content information file, and storing the result of encryption.

That is, even if the length of content information to be changed is short, the entire content information file, which is far longer than the content information, must be encrypted and decrypted to change the content information, thereby causing consumption of a large amount of resources.

### SUMMARY OF THE INVENTION

The present invention provides an apparatus and method for storing data by separately encrypting and decrypting content information files in directories using different encryption keys, thereby effectively changing content information.

According to one aspect of the present invention, there is provided an apparatus for storing data in a device, the apparatus comprising a directory key generator generating a directory key required for encrypting and decrypting the data by inputting a device-specific key to a key generating function, the device-specific key being unique information allocated to the device and stored in a secure region of the device, wherein the data is stored in at least one directory, and the directory key is used in encrypting and decrypting the data in units of directories.

The apparatus further includes an encryption unit encrypting the data using the directory key, and a storage unit storing the encrypted data in units of directories.

The directory key generator generates the directory key by inputting the device-specific key and directory information, which specifies the directory, into the key generating function when the device requests the data.

The directory information comprises at least one of the name of the directory, the storing capacity of the directory, the name of the data stored in the directory, and a time when the data is stored in the directory.

The apparatus further includes a decryption unit generating decrypted data by reading the encrypted data from the storage unit and decrypting the encrypted data using the directory key when the device requests the data.

The directory key may be obtained using a device key allocated to the device during broadcast encryption. The device-specific key may be a unique device key allocated to the device, and the unique device key is selected from device keys allocated using broadcast encryption.

Accordingly, it is possible to check whether the device-specific key matches the device through an after-sales service center, thereby increasing convenience in providing after-sales service, e.g., when exchanging devices. Specifically, identification data of the device key is stored outside the device or together with encrypted data. When a current device must be exchanged with another device, a key used in encrypting a directory is obtained from the AS center using the identification data of the device key. Then, encrypted content can be used using the obtained key.

According to another aspect of the present invention, there is provided a method of storing data in a device, the method comprising generating a directory key by inputting a device-specific key into a key generating function, the directory key used to encrypt and decrypt the data, the device-specific key allocated to the device and stored in a secure region of the device, wherein the data is stored in at least one directory, and the directory key is used to encrypt and decrypt the data in units of directories.

### BRIEF DESCRIPTION OF THE DRAWINGS

The above and other aspects and advantages of the present invention will become more apparent by describing in detail exemplary embodiments thereof with reference to the attached drawings in which:

FIG. 1A is a block diagram of a conventional apparatus, e.g., a DVD player, which reproduces data;

FIG. 1B illustrates a data structure of general content information;

FIG. 1C is a block diagram of a conventional apparatus for storing data;

FIG. 2 is a flowchart illustrating a method of storing data using the apparatus of FIG. 1C;

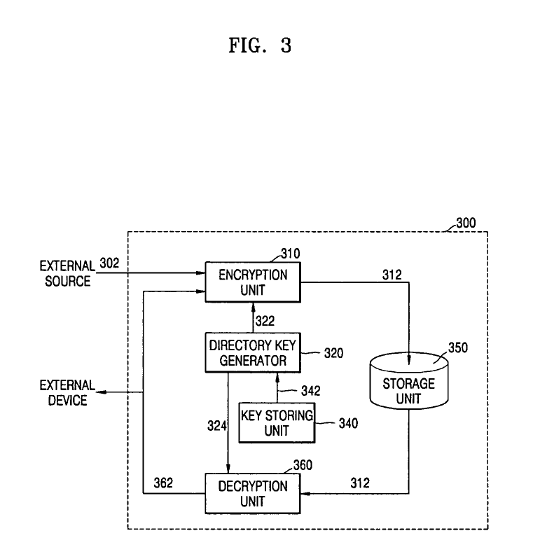

FIG. 3 is a block diagram of an apparatus for storing data according to an embodiment of the present invention;

FIG. 4 is a block diagram of an apparatus for storing data according to another embodiment of the present invention;

FIGS. 5A through 5D illustrate key generating functions;

FIG. 6 is a flowchart illustrating a method of storing data according to an embodiment of the present invention;

FIG. 7 is a flowchart illustrating a method of storing data according to another embodiment of the present invention;

FIGS. 8A and 8B are diagrams illustrating methods of using content information stored using a method according to the present invention, according to embodiments of the present invention;

FIGS. 8C and 8D are diagrams illustrating methods of changing content information stored using a method according to the present invention, according to embodiments of the present invention; and

FIGS. 8E and 8F are diagrams illustrating methods of deleting content information stored using a method according to the present invention, according to embodiments of the present invention.

### DETAILED DESCRIPTION OF THE INVENTION

Hereinafter, exemplary embodiments of the present invention will be described in detail with reference to the accompanying drawings. Like reference numerals are used to designate like or equivalent elements throughout this disclosure.

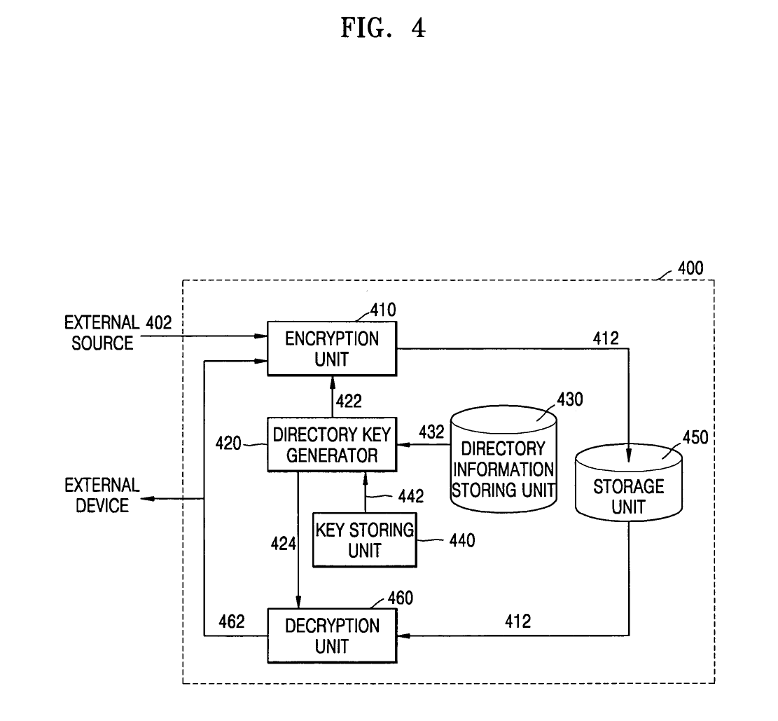

FIG. 3 is a block diagram of an apparatus 300 for storing data according to an embodiment of the present invention. The apparatus 300 includes an encryption unit 310, a directory key generator 320, a key storing unit 340, a storage unit 350, and a decryption unit 360.

The operation of the apparatus 300 will now be described with respect to two cases where content information 302 is obtained from an external source and stored in the apparatus 300, and where content information 362 is extracted from the apparatus 300 when an external device requests the content information 362.

When the encryption unit 310 receives the content information 302 from an external source, the directory key generator 320 generates a directory key 322 by inputting a device-specific key 342 given from the key storing unit 340 to a key generating function ƒ( ). The generated directory key 322 is used to encrypt and decrypt the content information 302.

According to an embodiment of the present invention, the device-specific key 342 is unique information given to the apparatus 300. The device-specific key 342 is stored in the key storing unit 340. The key storing unit 340 is a secure region such as a flash memory.

Alternatively, the device-specific key 342 may be a unique device key peculiarly allocated to a device during a broadcast encryption process. That is, the unique device key matches a particular device and is selected from a set of device keys allocated to a plurality of devices during the broadcast encryption process.

Alternatively, the particular device key 342 may be a unique secret key allocated to a data storage apparatus that uses a public key structure that requires a pair of a secret key and a public key.

Alternatively, the particular device 342 may be unique information given to an apparatus for storing data, using various methods.

Since the device-specific key 342 is unique information allocated to the apparatus 300 and the directory key 322 is generated using the device-specific key 342, the directory key 322 is characteristic to the apparatus for storing data, thereby accomplishing binding of content to a particular device.

The encryption unit 310 generates encrypted content information 312 by encrypting the content information 302 using the directory key 322, and stores the encrypted content information 312 in the storage unit 350.

When the external device requests the encrypted content information 312, the directory key generator 320 generates a directory key 324 by inputting the device-specific key 342 given from the key storing unit 340 to a key generating function ƒ( ).

Then, the decryption unit 360 extracts the encrypted content information 312 from the storage unit 350, and generates decrypted content information 362 by decrypting the encrypted content information 352 using the directory key 324.

The decrypted content information 362 is transmitted to the external device. After the external device uses the decrypted content information 362, the decrypted content information 362 is encrypted again by the encryption unit 310 and stored in the storage unit 350. For instance, when a content key is included in content information and an external device is a moving image reproduction apparatus that desires to reproduce encrypted content, the external device requests a data reproduction apparatus to provide content information. However, since the content information is encrypted, it must be decrypted and provided to the external device, and then encrypted and stored again in a storage unit of the data reproduction apparatus unit.

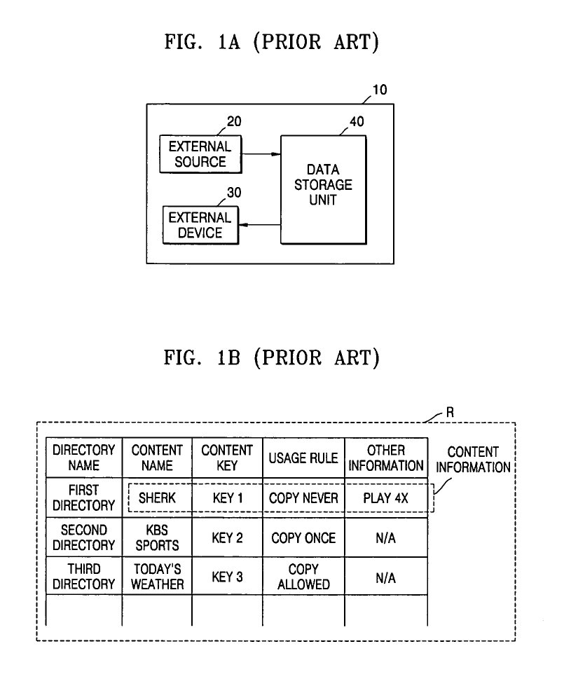

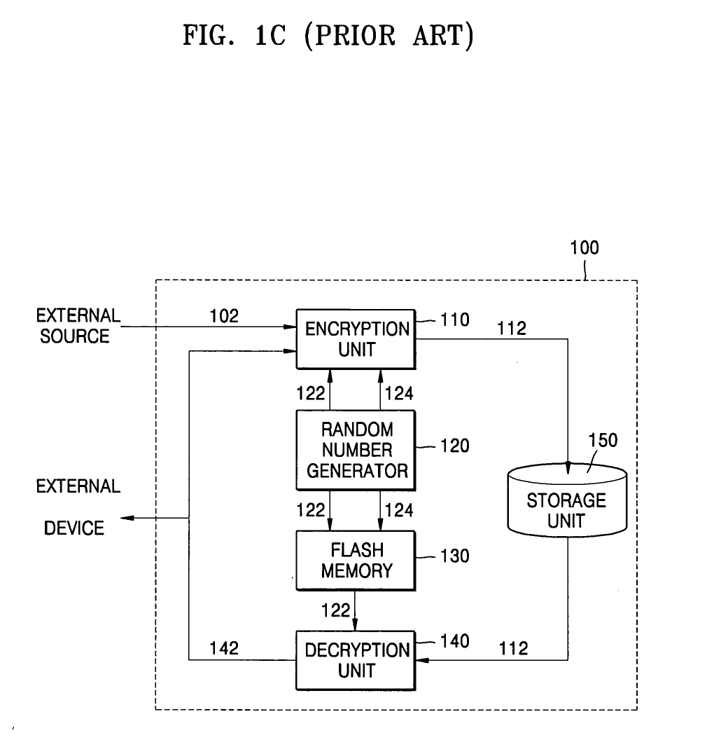

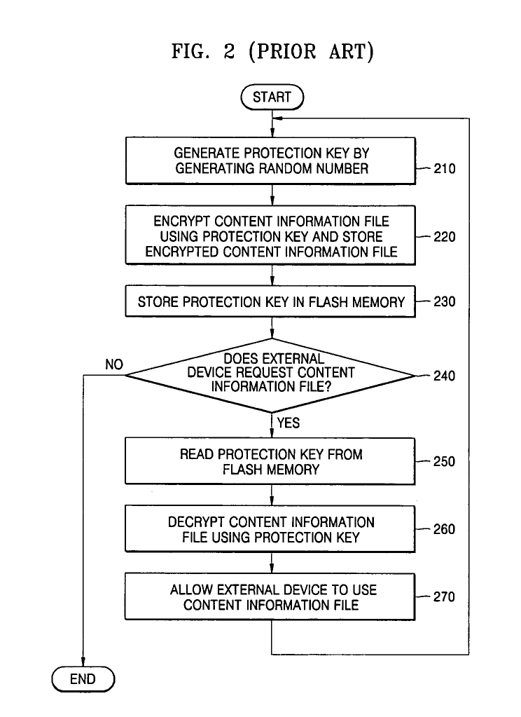

As described above, the content information 312 is stored in and extracted from the storage unit 350 in units of directories in the apparatus 300 of FIG. 3, not a content information file as represented in FIG. 1B in the apparatus 100 of FIG. 1C. That is, according to the present invention, only content information stored in one of the directories is encrypted and decrypted, thereby minimizing consumption of resources required for the encryption and decryption.

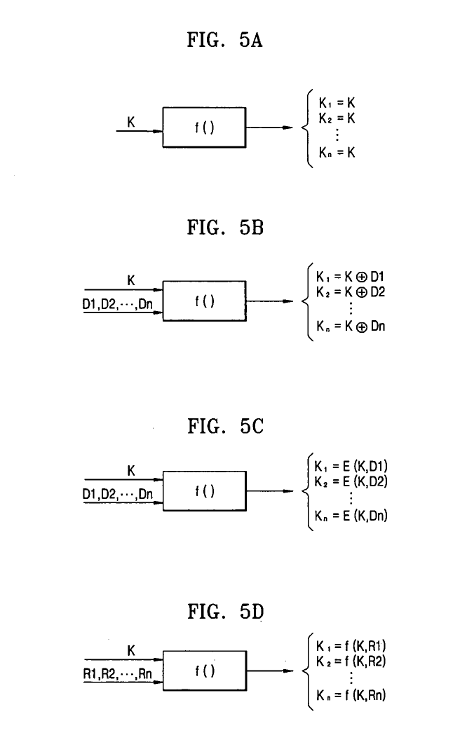

FIG. 4 is a block diagram of an apparatus 400 for storing data according to another embodiment of the present invention. The apparatus 400 includes an encryption unit 410, a directory key generator 420, a directory information storing unit 430, a key storing unit 440, a storage unit 450, and a decryption unit 460.

Referring to FIG. 4, when content information 402 is input to the encryption unit 410 from an external source, the directory key generator 420 generates a directory key 422 by inputting a device-specific key 442 given from the key storing unit 440 and directory information 432 given from the directory information storing unit 430 to a key generating function ƒ( ). The directory key 422 is used to encrypt and decrypt the content information 402.

Similarly, the device-specific key 442 is peculiarly allocated to the apparatus 400 and stored in a secure region of the apparatus 400.

The directory information 432 specifies directories such as those illustrated in FIG. 1B, which can be disclosed to the public. The directory information 432 may include directory names, the names of contents stored in the directories, the lengths of the contents, and time when each of the content is stored. The directory information 432 may be stored in a region of the apparatus 400, the safety of which is not guaranteed.

Similar to the apparatus 300 of FIG. 3, the device-specific key 442 is information peculiarly given to the apparatus 400 and the directory key 422 is generated using the device-specific key 442. Therefore, the directory key 422 is also characteristic to the apparatus 400, thereby accomplishing binding content to a specific device.

The encryption unit 410 generates encrypted content information 412 by encrypting the content information 402 using the directory key 422, and stores it in the storage unit 450.

When an external device requests the encrypted content information 412, the directory key generator 420 generates a directory key 424 by inputting the device-specific key 442 given from the key storing unit 440 to a key generating function ƒ( ).

The decryption unit 460 extracts the encrypted content information 412 from the storage unit 450, and generates decrypted content information 462 by decrypting the encrypted content information 412 using the directory key 424.

The decrypted content information 462 is transmitted to the external device. After the external device uses the decrypted content information 462, the decrypted content information 462 is encrypted again by the encryption unit 410 and stored in the storage unit 450. When a content key is included in content information and an external device is a moving image reproduction apparatus that desires to reproduce encrypted content, the external device requests a data storing apparatus to provide the content information. However, since the content information is encrypted, it must be decrypted and then provided to the external device, and encrypted and stored again as described above.

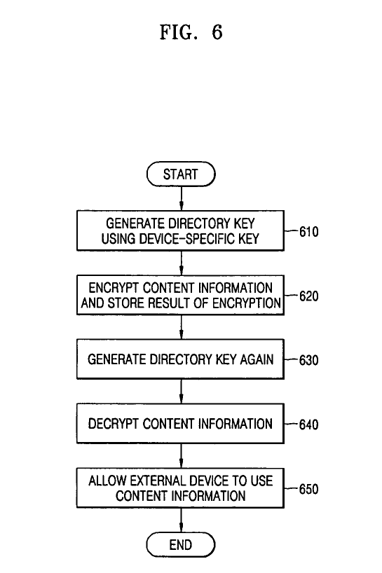

If the key generating function f( ) described with reference to FIG. 3 and FIG. 4 produces directory keys K₁, K₂, . . . , Kₙ using a device-specific key K, the type of the key generating function ƒ( ) is not limited. FIGS. 5A through 5D illustrate key generating functions.

Referring to FIG. 5A, directory keys K₁, K₂, . . . , Kₙ, which are respectively used to encrypt content information files in directories, correspond to a device-specific key K used to encrypt content information files in directories. As previously mentioned, the device-specific key K may be a unique device key or a secret key given to the apparatus 300. The directory keys K₁, K₂, . . . , Kₙ are given by:

$$\begin{matrix}{K}_{1} = f ( K ) = K \\ {K}_{2} = f ( K ) = K \\ ⋮ \\ {K}_{n} = f ( K ) = K\end{matrix} \qquad ( 1 )$$

Accordingly, all content information I₁, I₂, . . . , Iₙ are encrypted using the directory keys K₁, K₂, . . . , Kₙ which are equal to one another.

Referring to FIGS. 5B and 5C, directory keys K₁, K₂, . . . , Kₙ are generated using a device-specific key K and directory information D1, D2, . . . , Dₙ, respectively. The directory keys K₁, K₂, . . . , Kₙ of FIG. 5B and the directory keys K₁, K₂, . . . , Kₙ of FIG. 5C are given by:

$$\begin{matrix}{K}_{1} = f ( K , D1 ) = K ⊕ D1 \\ {K}_{2} = f ( K , D2 ) = K ⊕ D2 \\ ⋮ \\ {K}_{n} = f ( K , Dn ) = K ⊕ Dn ,\end{matrix} \qquad ( 2 )$$

wherein D1, D2, . . . , Dn denote directory information regarding directories 1, 2, . . . , n, and ⊕ denotes an XOR operation.

The device-specific key K or the directory information D1, D2, . . . , Dn may be hashed to equalize bit value(s) thereof before the XOR operation is performed thereon.

$$\begin{matrix}{K}_{1} = f ( K , D1 ) = E ( K , D1 ) \\ {K}_{2} = f ( K , D2 ) = E ( K , D2 ) \\ ⋮ \\ {K}_{n} = f ( K , Dn ) = E ( K , Dn ) ,\end{matrix} \qquad ( 3 )$$

wherein E(K,Dn) denotes a value obtained by encrypting the directory information Dn using the device-specific key K.

Referring to FIG. 5D, directory keys K₁, K₂, . . . , Kₙ are generated using a device-specific key K and random numbers R1, R2, . . . Rn, respectively. The directory keys K₁, K₂, . . . , Kₙ of FIG. 5D are given by:

$$\begin{matrix}{K}_{1} = f ( K , R1 ) = K ⊕ R1 & ( 4 ) \\ {K}_{2} = f ( K , R2 ) = K ⊕ R2 & \\ ⋮ & \\ {K}_{n} = f ( K , Rn ) = K ⊕ Rn , & \\ {K}_{1} = f ( K , R1 ) = E ( K , R1 ) & ( 5 ) \\ {K}_{2} = f ( K , R2 ) = E ( K , R2 ) & \\ ⋮ & \\ {K}_{n} = f ( K , Rn ) = E ( K , Rn ) , & \end{matrix}$$

wherein R1, R2, . . . , Rn denote random numbers that are allocated to directories 1, 2, . . . , n, respectively, and newly generated whenever content information is stored in the directories 1, 2, . . . , n.

The random numbers R1, R2 . . . . , Rn are stored in the apparatus 400, and extracted whenever the content information is used.

In general, to enable a data storing apparatus to generate a directory key using a device-specific key, an after-sales service (AS) center must be aware of the device-specific key peculiarly given to the data storing apparatus. There are cases where a storage unit must be installed into new hardware due to a fault of the data storing apparatus, and a new storage unit must be installed into the data storing apparatus due to the overflow of the storage unit. In these cases, the AS center must be aware of the device-specific key to allow the data storing apparatus to decrypt encrypted content information. Therefore, a serial number allocated to the data storing apparatus is marked on the exterior of the data storing apparatus, and the device-specific key and a table that match the serial number are provided to the AS center.

When exchanging the storage unit with a new one, the AS center records a device-specific key matching the data storing apparatus in a flash memory of the exchanged data storing apparatus.

Alternatively, a directory key may be generated using a set of device keys.

In broadcast encryption, each of data storing apparatuses includes a device key set composed of at least one device key, e.g., DK1, DK2, . . . , DKm. When the number m of device keys is equal to or greater than the number n of directories, the device key DK1, DK2, . . . , DKm may be used as directory keys. In this case, the directory keys are given by:

$$\begin{matrix}{K}_{1} = DK1 \\ {K}_{2} = DK2 \\ ⋮ \\ {K}_{n} = DKn\end{matrix} \qquad ( 6 )$$

In broadcast encryption, some of the device keys DK1, DK2, DKm are shared by another data storing apparatus. If the device keys DK1, DK2, DK4, DK6, and DK7 are allocated to a data storing apparatus A and the device keys DK1, DK2, DK4, DK6, and DK9 are allocated to a data storing apparatus B, the data storing apparatus A can decrypt directories stored in the data storing apparatus B using the device keys DK1, DK2, DK4, and DK6.

To prevent this problem, directory keys are generated to be characteristic to a data storing apparatus, using a device key. To make directory keys be characteristic to a data storing apparatus, the directory keys may be generated using the device key, i.e., a unique device key DKm, which is peculiarly allocated to the data storing device. In this case, the generated directory keys are given by:

$$\begin{matrix}{K}_{1} = f ( DK1 , DKm ) = DK1 ⊕ DKm \\ {K}_{2} = f ( DK2 , DKm ) = DK2 ⊕ DKm \\ ⋮ \\ {K}_{n} = f ( DKn , DKm ) = DKn ⊕ DKm ,\end{matrix} \qquad ( 7 )$$

wherein K₁, K₂, . . . , Kₙ denote directory keys; DK1, DK2, . . . , DKm denote device keys; and DKm denotes a device key peculiarly allocated to a data storing apparatus. In Equation (7), the number m of device keys must be greater than the number n of directory keys, i.e., m>n.

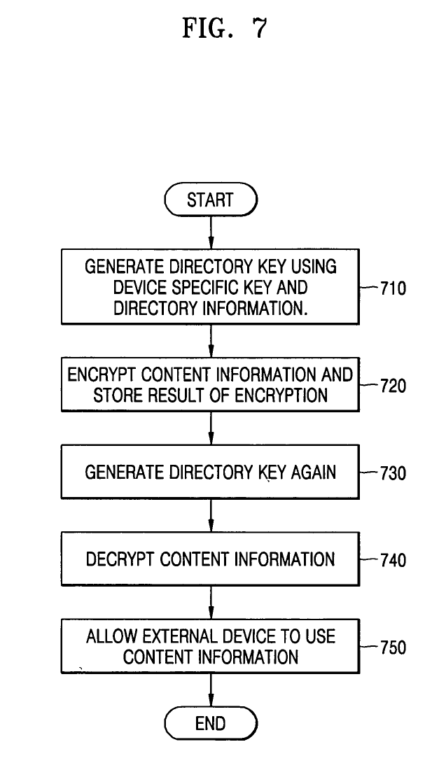

FIG. 6 is a flowchart illustrating a method of storing data using the apparatus 300 of FIG. 3, according to an embodiment of the present invention. Referring to FIG. 6, when the content information 302 is obtained from an external source, the directory key generator 320 generates the directory key 322 by inputting the device-specific key 342 given from the key storing unit 340 to a key generating function ƒ( ) (operation 610).

The device-specific key 342 may be a unique device key allocated to the apparatus 300 during broadcast encryption. The unique device key is allocated to a data storing apparatus, selected from a set of device keys allocated to a plurality of data storing apparatuses during broadcast encryption.

Alternatively, the device-specific key 342 may be a unique secret key allocated to the apparatus 300 when the data storing apparatus uses a public key structure that requires a pair of a secret key and a public key.

Alternatively, the device-specific key 342 may be any unique information provided to the apparatus 300, using various methods.

Next, the encryption unit 310 generates the encrypted content information 312 by encrypting the content information 302 using the directory key 322, and stores the encrypted content information 312 in the storage unit 350 (operation 620).

Next, when an external device requests the encrypted content information 312, the directory key generator 320 generate the directory key 342 by inputting the device-specific key 342 given from the key storing unit 340 to a key generating function ƒ( ) (operation 630).

Next, the decryption unit 360 extracts the encrypted content information 312 from the storage unit 350, and generates the decrypted content information 362 by decrypting the encrypted content information 312 using the directory key 324 (operation 640).

Next, the decrypted content information 362 is transmitted to the external device, and encrypted again by the encryption unit 310 and stored in the storage unit 350 after the external device uses the decrypted content information 362 (operation 650).

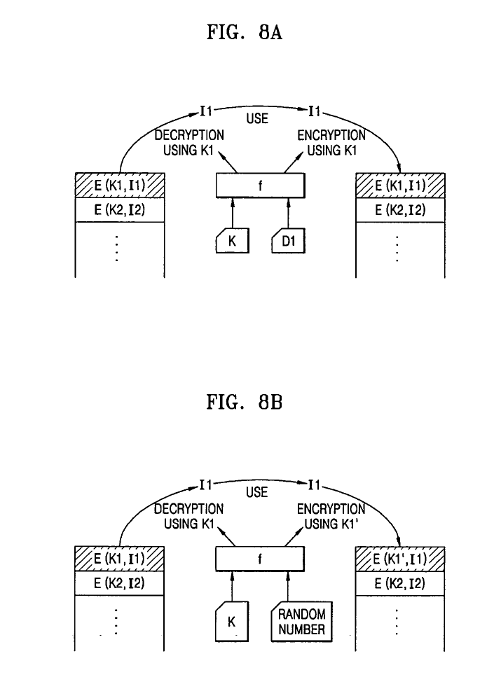

FIG. 7 is a flowchart illustrating a method of storing data using the apparatus 400 of FIG. 4, according to another embodiment of the present invention. Referring to FIG. 7, when the content information 402 is obtained from an external source, the directory key generator 420 generates the directory key 422 by inputting the device-specific key 442 given from the key storing unit 440 and the directory information 432 given from the directory storing unit 430 to a key generating function ƒ( ) (operation 710).

The key generating function ƒ( ) may be selected from the functions illustrated in FIG. 5B through 5D.

Next, the encryption unit 410 generates the encrypted content information 412 by encrypting the content information 402 using the directory key 422, and stores the encrypted content information 412 in the storage unit 450 (operation 720).

Next, when an external device requests the encrypted content information 412, the directory key generator 420 generates the directory key 424 by inputting the device-specific key 442 given from the key storing unit 440 to the key generating function ƒ( ) (operation 730).

Next, the decryption unit 460 extracts the encrypted content information 412 from the storage unit 450, and generates the decrypted content information 462 by decrypting the encrypted content information 412 using the directory key 424 (operation 740).

Next, the decrypted content information 462 is transmitted to the external device, and encrypted again by the encryption unit 410 and stored in the storage unit 450 after the external uses the decrypted content information 462 (operation 750).

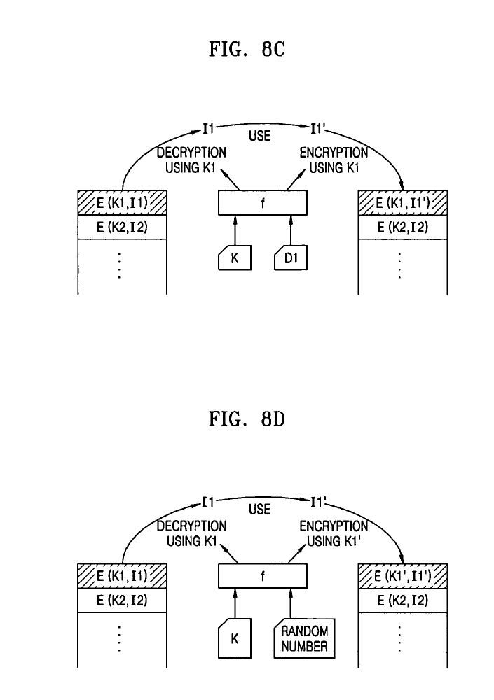

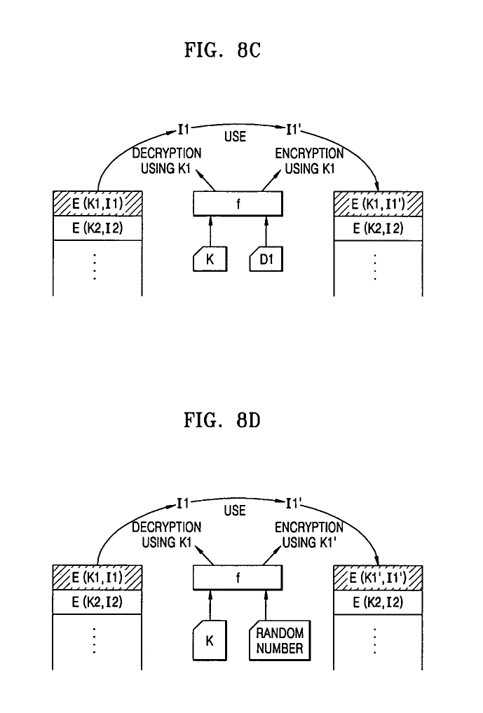

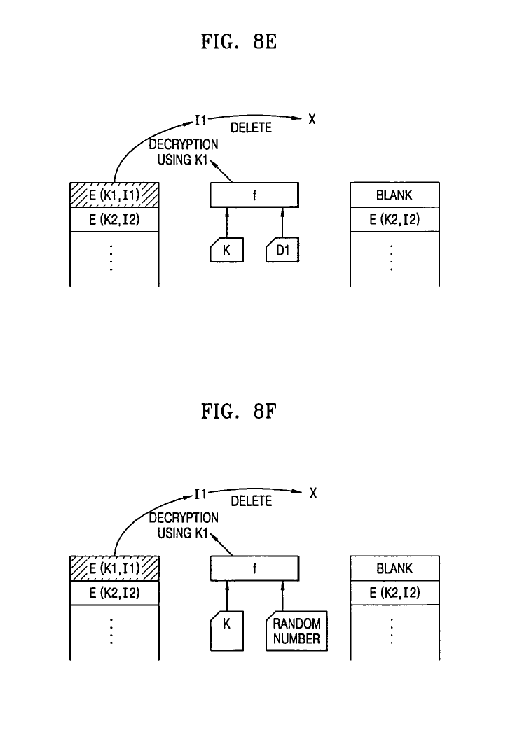

FIGS. 8A and 8B are diagrams illustrating methods of using encrypted content information E(K1,I1), which is stored using a method according to embodiments of the present invention. Referring to FIG. 8A, the encrypted content information E(K1,I1) is decrypted using a directory key K1, and then encrypted using the directory key K1 and stored in a storage unit. That is, the directory key K1 is used in encrypting and decrypting the encrypted content information E(K1,I1), since the directory key K1 is generated using the device-specific key K and directory information D1 that will not be changed.

In contrast, referring to FIG. 8B, the encrypted content information E(K1,I1) is decrypted using a directory key K1, and then, encrypted using a directory key K1′ and stored in a storage unit. The directory key K1′ is different from the directory key K1, since the directory key K1′ is generated using a device-specific key K and a random number R1. The random number R1 changes every time a random number is generated, and is stored in a data storing apparatus.

Referring to FIGS. 8A and 8B, only a part of a content information file, which contains content information I1, is encrypted and decrypted, thereby minimizing consumption of resources required for encryption and decryption.

FIGS. 8C and 8D are diagrams illustrating methods of changing encrypted content information E(K1,I1) stored using a method according to the present invention, according to embodiments of the present invention. The methods of FIGS. 8C and 8D are the same as those of FIGS. 8A and 8B, except that content information I1 is changed into content information I1′.

However, a smaller amount of resources is required when deleting the content information I1 than when changing the content information I1. FIGS. 8E and 8F are diagrams illustrating a method of deleting encrypted content information E(K1,I1) stored using a method according to the present invention, according to embodiments of the present invention.

Referring to FIGS. 8E and 8F, encryption and decryption are performed in units of directories according to the present invention, and thus, decryption is not required in deleting the content information I1. On the other hand, conventionally, since a content information file is totally encrypted, it must be encrypted again even when only one piece of content information stored in the content information file is deleted.

Accordingly, a method of storing data according to the present invention enables a piece of content information stored in a content information file to be deleted without having to encrypt again the content information file, thereby reducing consumption of resources.

Although the present invention has been described with respect to content information, the present invention is not limited to this type of information. That is, the present invention can be applied to various types of data that can be divided in units of directories.

The present invention can be embodied as a computer readable program. Codes or code segments constituting the program could have been easily derived by computer programmers in the art. The program can be stored in a computer readable medium, and a method of storing data according to the present invention is performed when the program is read and executed using a computer. Here, the computer readable medium may be any recording apparatus capable of storing data that is read by a computer system, e.g., a magnetic recording medium, an optical recording medium, and a carrier wave.

As described above, according to the present invention, data, which is to be stored in a data storing apparatus, is divided into units of directories in which the data will be input to or output from the data storing apparatus, and the respective directories are encrypted using different directory keys, thereby minimizing consumption of resources required for encryption and decryption.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for storing data in a device, the apparatus comprising:
a directory key generator generating a directory key required for encrypting and decrypting the data by inputting a device-specific key to a key generating function, the device-specific key being unique information allocated to the device and stored in a secure region of the device,
wherein the data is stored in at least one directory, and
the directory key is used in encrypting and decrypting the data in units of directories.

2. The apparatus of claim 1, further comprising:
an encryption unit encrypting the data using the directory key; and
a storage unit storing the encrypted data in units of directories.

3. The apparatus of claim 1, wherein the directory key generator generates the directory key by inputting the device-specific key and directory information, which specifies the directory, into the key generating function when the device requests the data.

4. The apparatus of claim 3, wherein the directory information comprises at least one of the name of the directory, the storing capacity of the directory, the name of the data stored in the directory, and a time when the data is stored in the directory.

5. The apparatus of claim 3, wherein the directory key is obtained by performing an XOR operation on the device-specific key and the directory information.

6. The apparatus of claim 3, wherein the directory key is obtained by encrypting the directory information using the device-specific key.

7. The apparatus of claim 1, further comprising a decryption unit generating decrypted data by reading the encrypted data from the storage unit and decrypting the encrypted data using the directory key when the device requests the data.

8. The apparatus of claim 1, wherein the directory key is obtained using a device key allocated to the device during broadcast encryption.

9. The apparatus of claim 7, wherein the device-specific key is a unique device key allocated to the device, and the unique device key is selected from device keys allocated using broadcast encryption.

10. The apparatus of claim 1, wherein whether the device-specific key matches the device is determined at an after-sales service center,
wherein an encryption key for the directory is extracted at the after-sales service center using the device-specific key when the device is replaced with another device.

11. The apparatus of claim 1, wherein the data is content information regarding content to be reproduced by the device, and
the content information comprises at least one of a content key and usage rules of the content which are required to encrypt and decrypt the content.

12. A method of storing data in a device, comprising:
generating a directory key by inputting a device-specific key into a key generating function, the directory key used to encrypt and decrypt the data, the device-specific key allocated to the device and stored in a secure region of the device,
wherein the data is stored in at least one directory, and
the directory key is used to encrypt and decrypt the data in units of directories.

13. The method of clam 12, further comprising:
generating encrypted data by encrypting the data using the directory key; and
storing the encrypted data in units of directories.

14. The method of claim 12, wherein the generation of the directory key comprises when the device requests the data, generating the directory key by inputting the device-specific key and directory information, which specifies the directory, into the key generating function.

15. The method of claim 14, wherein the directory information comprises at least one of the name of the directory, the storing capacity of the directory, the name of the data stored in the directory, and time when the data is stored in the directory.

16. The method of claim 14, wherein the generation of the directory key comprises performing an XOR operation on the device-specific key and the directory information.

17. The method of claim 14, wherein the generation of the directory key comprises encrypting the directory information using the device-specific key.

18. The method of claim 12, further comprising when the device requests the data, generating decrypted data by decrypting the encrypted data using the directory key.

19. The method of claim 12, wherein the directory key is generated using a device key allocated to the device during broadcast encryption.

20. The method of claim 18, wherein the device-specific key is a unique device key peculiarly allocated to the device, and the unique device key is selected from device keys allocated using broadcast encryption.

21. The method of claim 12, wherein the data is content information regarding content to be reproduced by the device, and the content information comprises at least one of a content key used to encrypt and decrypt the content, and usage rules of the content.

22. The method of claim 12, wherein whether the device-specific key matches the device is determined at an after-sales center,
wherein an encryption key for the directory is extracted at the after-sales center using the device-specific key when the device must be replaced with another device.

23. A computer readable recording medium storing a program for executing the method of claim 12 using a computer.
